(19) United States
(12) Patent Application Publication
(10) Pub. No.: US 2016/0292009 A1
(43) Pub. Date: Oct. 6, 2016

(54) EXECUTION OFFLOADING THROUGH SYSCALL TRAP INTERFACE

(71) Applicants: David KAPLAN, Modi'in (IL); Aviad SACHS, Modi'in (IL); Shahar TAITE, Kfar Saba (IL)

(72) Inventors: David KAPLAN, Modi'in (IL); Aviad SACHS, Modi'in (IL); Shahar TAITE, Kfar Saba (IL)

(21) Appl. No.: 15/037,440

(22) PCT Filed: Dec. 20, 2013
(86) PCT No.: PCT/US2013/077199

§ 371 Date: May 18, 2016

(51) Int. Cl. G06F 9/50; H04L 29/06

(52) U.S. Cl. CPC G06F 9/5027; H04L 67/42; G06F 2209/509

(57) ABSTRACT

Technologies for offloading execution of program code from a client computing device include a server to execute program code received from the client computing device. The server monitors execution of the program code to determine whether an instruction of the program code to be executed requires a system call. In response to determining the instruction requires execution of a system call, the server transmits the instruction to the client computing device for execution. The server receives a response from the client computing device in response to execution of the instruction that requires execution of the system call by the client computing device.

### BACKGROUND

Power consumption, security, performance, features, and size are critical parameters in a constantly evolving computing ecosystem, particularly with the growing use of mobile computing devices. For example, mobile computing devices are oftentimes designed to minimize power consumption and device/component size while maximizing performance, security, and features. With the advent of shared computing mechanisms such as cloud computing, it is possible to offload execution from a local computing device (e.g., a mobile computing device) to a remote computing device (e.g., a server in a cloud computing environment). Typically, such execution offloading involves transferring the entire environment context from the local computing device to the remote computing device and/or modifications to the applications that are to be run remotely.

Computing devices generally use multiple modes of execution during the execution of an application. For example, a particular computing device may have a non-privileged mode in which a program is generally executed and a privileged mode in which an operating system kernel is executed. In order to access system resources or perform hardware-related services (e.g., accessing hard disc data), an executing program utilizes system calls to request a corresponding service to be performed by the operating system.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for offloading execution of program code from a client computing device to a server;

FIG. 2 is a simplified block diagram of at least one embodiment of an environment of the system of FIG. 1;

FIG. 3 is a simplified flow diagram of at least one embodiment of a method for offloaded execution of program code by the server of FIG. 1; and

FIG. 4 is a simplified flow diagram of at least one embodiment of a method for offloading execution of program code by the client computing device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

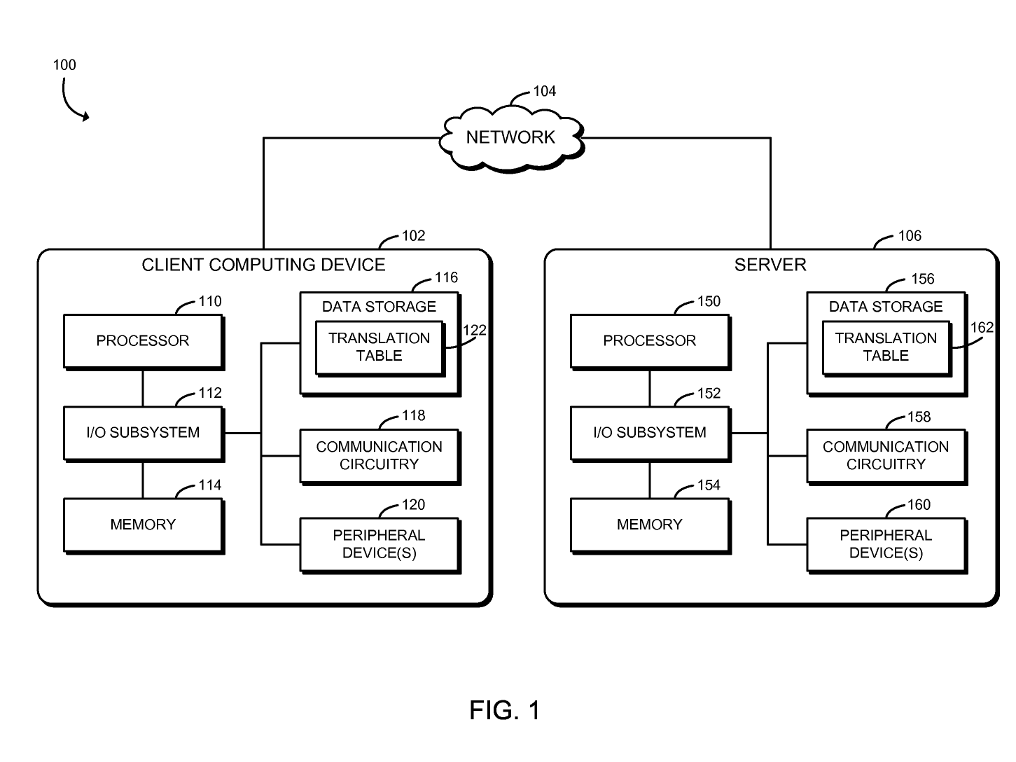

Referring now to FIG. 1, a system 100 for offloading execution of program code includes a client computing device 102, a network 104, and a server 106. In use, as described in more detail below, the client computing device 102 is configured to transmit program code (e.g., an application) to the server 106 for offloaded execution of the program code. If the server 106 encounters a program code instruction requiring a system call that should be executed by the client computing device 102, the server 106 transmits the instruction to the client computing device 102 for execution. In some cases, both the client computing device 102 and the server 106 may execute the system call instruction.

The client computing device 102 may be embodied as any type of computing device capable of executing program code, communicating with the server 106 over the network 104, and performing the functions described herein. For example, the client computing device 102 may be embodied as a cellular phone, smartphone, tablet computer, netbook, notebook, Ultrabook™, laptop computer, personal digital assistant, mobile Internet device, desktop computer, Hybrid device, and/or any other computing/communication device. As shown in FIG. 1, the illustrative client computing device 102 includes a processor 110, an input/output (“I/O”) subsystem 112, a memory 114, a data storage 116, a communication circuitry 118, and one or more peripheral devices 120. Of course, the client computing device 102 may include other or additional components, such as those commonly found in a typical computing device (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the client computing device 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the client computing device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the client computing device 102, on a single integrated circuit chip.

The data storage 116 may be embodied as any type of device or devices configured for short-term or long-term storage of data such as, for example, memory devices and circuits, memory cards, hard disk drives, solid-state drives, or other data storage devices. As shown in FIG. 1, the data storage 116 includes a translation table 122. The translation table 122 maps correspondences between local memory addresses of the client computing device 102 and the server 106 as discussed in more detail below. The translation table 122 may be stored on the data storage 116 as any suitable data structure (e.g., a database).

The communication circuitry 118 may be embodied as any communication circuit, device, or collection thereof, capable of enabling communications between the client computing device 102 and other remote devices (e.g., the server 106) over the network 104. To do so, the communication circuitry 118 may use any suitable communication technology (e.g., wireless or wired communications) and associated protocol (e.g., Ethernet, Bluetooth®, Wi-Fi®, WiMAX, etc.) to effect such communication depending on, for example, the type of network, which may be embodied as any type of communication network capable of facilitating communication between the client computing device 102 and remote devices. The peripheral devices 120 of the client computing device 102 may include any number of additional peripheral or interface devices. The particular devices included in the peripheral devices 120 may depend on, for example, the type and/or intended use of the client computing device 102.

The network 104 may be embodied as any type of communication network capable of facilitating communication between the client computing device 102 and the server 106. As such, the network 104 may include one or more networks, routers, switches, computers, and/or other intervening devices. For example, the network 104 may be embodied as or otherwise include one or more local or wide area networks, publicly available global networks (e.g., the Internet), cellular networks, telephone networks, ad hoc networks, or any combination thereof.

The server 106 may be embodied as any type of computing device capable of performing the functions described herein. For examples, in some embodiments, the server 106 may be similar to the client computing device 102 as described above. That is, the server 106 may be embodied as an enterprise-level server computer, a desktop computer, a laptop computer, a tablet computer, a cellular phone, smartphone, personal digital assistant, mobile Internet device, netbook, notebook, Ultrabook™, Hybrid device, and/or any other computing/communication device. Further, the server 106 may include components similar to those of the client computing device 102 discussed above. For example, as shown in the illustrative embodiment of FIG. 1, the server 106 includes a processor 150, an I/O subsystem 152, a memory 154, a data storage 156 (e.g., for storing a translation table 162), a communication circuitry 158, and one or more peripheral devices 160. The description of those components of the client computing device 102 is equally application to the description of corresponding components of the server 106 and is not repeated herein for clarity of the description. Further, it should be appreciated that the server 106 may include other components, sub-components, and devices commonly found in a computing device or server, which are not discussed above in reference to the client computing device 102 and not discussed herein for clarity of the description. The translation table 162 may be substantially similar to the translation table 122 discussed above and may map correspondences between local memory addresses of the server 106 and the client computing device 102. Although two translation tables 122, 162 are shown in FIG. 1, in some embodiments, a single translation table 122, 162 is stored on only one of the client computing device 102 or the server 106 (i.e., not on both devices).

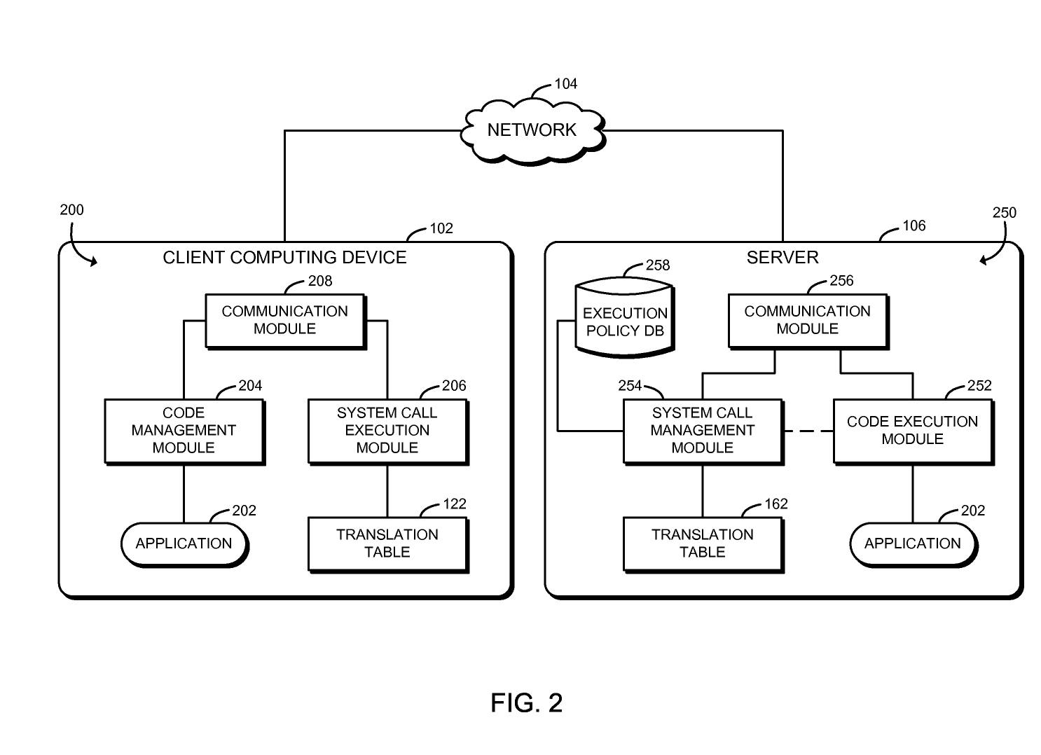

Referring now to FIG. 2, in use, the client computing device 102 of the system 100 establishes an environment 200, and the server 106 of the system 100 establishes an environment 250 for offloaded execution of program code. As discussed below, the server 106 executes program code received from the client computing device 102. If an instruction of program code requires execution of a system call by the client computing device 102 (e.g., to access a file), the server 106 transmits the instruction to the client computing device 102 for execution.

The illustrative environment 200 of the client computing device 102 includes a code management module 204, a system call execution module 206, and a communication module 208. Furthermore, the environment 250 of the server 106 in the illustrative embodiment includes a code execution module 252, a system call management module 254, and a communication module 256. Each of the code management module 204, the system call execution module 206, the communication module 208, the code execution module 252, the system call management module 254, and the communication module 256 may be embodied as hardware, software, firmware, or a combination thereof. Additionally, in some embodiments, one of the illustrative modules may form a portion of another module (e.g., the code execution module 252 may form a portion of the system call management module 254).

The code management module 204 of the client computing device 102 transmits program code to the server 106 over the network 104 for execution (e.g., via the communication module 208). The program code may be embodied as, for example, one or more binary application files or other program code to execute an application 202. As discussed below, in the illustrative embodiment, the program code is transmitted to the server 106 for execution without any modifications to the code. In response to receipt of the program code, the server 106 is configured to execute the transmitted program code. If the server 106 determines that an instruction of the program code includes a system call that requires execution by the client computing device 102, the server 106 transmits the instruction to the client computing device 102 for execution. Accordingly, the code management module 204 of the client computing device 102 receives such instruction (e.g., with the communication module 208).

The system call execution module 206 executes instructions received from the server 106. That is, the system call execution module 206 executes instructions of the offloaded program code determined by the server 106 to include system calls requiring execution by the client computing device 102. The system call execution module 206 (i.e., in conjunction with the communication module 208) transmits a response (e.g., a result of the system call and/or memory mapping data) to the server 106 based on the execution of the system call. Additionally, as discussed in greater detail below, the system call execution module 206 may translate an address of the system call between a memory address of the server 106 and a memory address of the client computing device 102, allocate memory in a local context of the client computing device 102 (e.g., in the memory 114 or the data storage 116), and/or update the translation table 122 (e.g., based on memory allocation).

The communication module 208 handles the communication between the client computing device 102 and remote devices (e.g., the server 106) through the network 104. As discussed above, the code management module 204 and the system call execution module 206 communicate with the server 106 via the communication module 208 regarding instructions involving system calls.

As shown in FIG. 2, the server 106 includes the code execution module 252, the system call management module 254, and the communication module 256. The code execution module 252 loads and executes the program code received from the client computing device 102 for execution. Additionally, in some embodiments, the code execution module 252 initializes the translation table 162 (e.g., during the loading of the program code) that translates addresses between memory addresses of the server 106 and memory addresses of the client computing device 102. Depending on the particular instruction of the program code executed, the code execution module 252 and/or the system call management module 254 may translate an address associated with a system call and/or update the translation table 162 based on execution of an instruction (e.g., an instruction requiring a system call).

The system call management module 254 monitors execution of the program code (i.e., the program code received from the client computing device 102 and executed by the code execution module 252) to determine whether an instruction of the program code to be executed requires a system call. In some embodiments, the system call management module 254 “traps” or intercepts any program code that initiates a system call. If a system call is identified and determined to require execution by the client computing device 102, the system call management module 254 transmits the instruction and, if needed, related content/data to the client computing device 102 for execution (e.g., via the communication module 256). Subsequently, the system call management module 254 receives a response from the client computing device 102 in response to execution of the instruction requiring execution of the system call by the client computing device 102.

It should be appreciated that the particular system calls, types of system calls, or instructions requiring execution by the client computing device 102 and/or the server 106 may vary depending on the particular embodiment and/or the offloaded program code. The system calls requiring execution by the client computing device 102 may include, for example, read, write, open, close, memory allocation, and other system calls. As shown in FIG. 2, an execution policy database 258 may be stored on the server 106 (i.e., as a suitable data structure) or may be otherwise accessible by the server 106 (e.g., stored on a remote device and accessible over the network 104). In the illustrative embodiment, the execution policy database 258 identifies the system calls to be handled by the client computing device 102, the system calls to be handled by the server 106, and/or the system calls to be handled by both the client computing device 102 and the server 106. In some embodiments, the execution policy database 258 may be received from, or otherwise updated by, the client computing device 102. For example, execution policies to be stored in the execution policy database 258 may be transmitted, along with the program code, by the client computing device 102 to the server 106. Such execution policies may be developed or defined by, for example, the designer of the program code. Additionally or alternatively, the execution policies may be determined or inferred by the server 106 (e.g. based on generic system calls). Regardless, the system call management module 254 compares identified system calls (or the instructions requiring the system calls) to the execution policy database 258 to determine how to handle each of the system calls. That is, the execution policy database 258 includes a list of system calls and identifies how each system call is to be handled locally (if at all) and remotely (if at all).

The communication module 256 of the server 106 may be similar to the communication module 208 of the client computing device 102. That is, the communication module 256 handles the communication between the server 106 and remote devices (e.g., the client computing device 102) through the network 104. As discussed above, the code execution module 252 and the system call management module 254 communicate with the client computing device 102 via the communication module 256 regarding instructions involving system calls. In some embodiments, the communication module 256 and the communication module 208 establish a secure communication link between the server 106 and the client computing device 102 for transmitting instructions and data related to system calls.

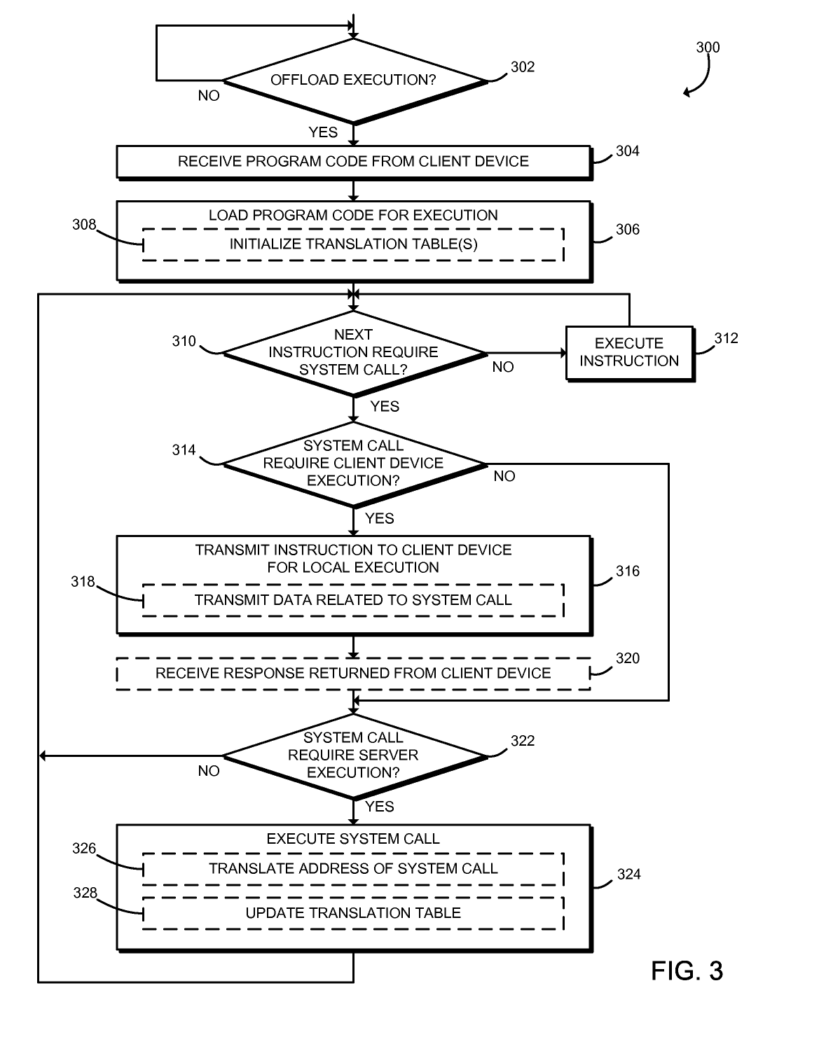

Referring now to FIG. 3, in use, the server 106 of the system 100 may execute a method 300 for offloading execution of program code from the client computing device 102 to the server 106. The illustrative method 300 begins with block 302 of FIG. 3 in which the server 106 determines whether to offload execution. It should be appreciated that, in some embodiments, the server 106 determines to offload execution in response to receiving program code for execution from the client computing device 102. As such, in block 304, the server 106 receives program code from the client computing device 102 in block 304. As discussed above, the program code may be embodied as one or more unmodified binary application files. In other words, the client computing device 102 may transmit the application files that the client computing device 102 would execute without modification to the server 106 for remote execution by the server 106. Additionally, as discussed above, the server 106 may receive execution policies defining system calls requiring execution by the client computing device 102 along with the program code in block 304 in some embodiments. In such embodiments, the server 106 stores any received execution policies in the execution policy database 258.

In block 306, the server 106 loads and executes the program code received from the client computing device 102. In doing so, the server 106 may initialize one or more translation tables for storing information regarding mappings/correspondences between local memory addresses of the client computing device 102 and the server 106 in block 308. In block 310, the server 106 determines whether the next instruction to be executed requires a system call. As discussed above, in some embodiments, the server 106 monitors the execution of the program code and “traps” the program code or generates an intercept if a system call is encountered, and the execution policy database 258 of the server 106 may include a list of instructions or system calls to trap.

If the server 106 determines the instruction does not require a system call, the server 106 executes the instruction in block 312. In other words, the server 106 continues executing the instructions of the program code received from the client computing device 102 until a system call is encountered. If the instruction is a system call, in block 314, the server 106 determines whether the system call requires execution by the client computing device 102. As indicated above, in order to make that determination, the server 106 may compare the instruction or system call to the execution policy database 258 of the server 106. The execution policy database 258 may indicate, for example, whether a particular type of system call or instruction requires execution by the client computing device 102 and/or the server 106. If the system call requires execution by the client computing device 102, the server 106 transmits the instruction requiring the system call to the client computing device 102 in block 316. Additionally, in block 318, the server 106 may transmit data associated with one or more parameters of the system call (e.g., a filename stored in the memory 154 and identified by a pointer) and/or other data/contents of the memory 154 related to execution of the system call and/or related system calls (e.g., subsequent system call). For example, in one embodiment, the system call may be an “open( )” system call that takes two parameters—a pointer to a memory location holding the filename and a mode. As discussed herein, each of the server 106 and the client computing device 102 allocate memory for the filename and establish a pointer mapping in the translation table, 122, 162. Additionally, at some point (e.g., contemporaneously with transmission of the instruction including the system call), the server 106 transmits the filename data to the client computing device 102, which the client computing device 102 stores in the appropriate memory location (i.e., based on the mapping stored in the translation table 122, 162). In doing so, the client computing device 102 is able to access the appropriate file related to the system call and/or subsequent related system call (e.g., system calls to access the same file).

Subsequently, in block 320, the server 106 may receive a response from the client computing device 102 based on execution of the transmitted system call by the client computing device 102. The contents of the response may vary depending on the particular embodiment and may include, for example, status information regarding the execution of the system call, data returned from the kernel of the client computing device 102 based on the system call, memory mapping data based on a memory allocation on the client computing device 102 and/or a mapping between a memory address of the server 106 and the client computing device 102, and/or other information related to the instruction or system call. In some embodiments, the client computing device 102 may execute the system call without providing a response to the server 106.

If the server 106 determines in block 314 that the system call does not require execution by the client computing device 102 or after receiving any response from the client computing device 102 in block 320, the method 300 advances to block 322. In block 322, the server 106 determines whether the system call requires execution by the server 106. It should be appreciated that the timing of such a determination may vary by embodiment. For example, in some embodiments, the server 106 may determine whether the system call requires execution by the server 106 contemporaneously with the determination of whether the system call requires execution by the client computing device 102 (e.g., by comparing the system call or type of system call to the execution policy database 258).

If the system call does not require execution by the server 106, the method 300 returns to block 310 in which the server 106 determines whether the next instruction requires a system call. That is, the server 106 executes the program code until another system call is encountered. If, however, the system call requires execution by the server 106, the server 106 executes the system call in block 324. In doing so, the server 106 may translate the address of the system call in block 326. For example, as discussed above, a system call may require execution by both the client computing device 102 and the server 106. Accordingly, the server 106 may translate an address of the system call or address related to the system call (e.g., related to memory allocation) between a memory address of the server 106 and a memory address of the client computing device 102. Additionally or alternatively, the server 106 may update the translation table 162 in block 328. For example, the server 106 may update the translation table 162 based on memory or address modifications (e.g., memory allocation) that occurred with respect to the execution of the system call by the server 106. If the system call does not require execution by the server 106 or in response to execution of the system call by the server 106, the method 300 returns to block 310 in which the server 106 determines whether the next instruction requires a system call. It should be appreciated that, in some embodiments, one or more of the blocks 302-328 may be performed in parallel (e.g., blocks 314-320 in parallel with blocks 322-328) or in another order than the order presented in FIG. 3.

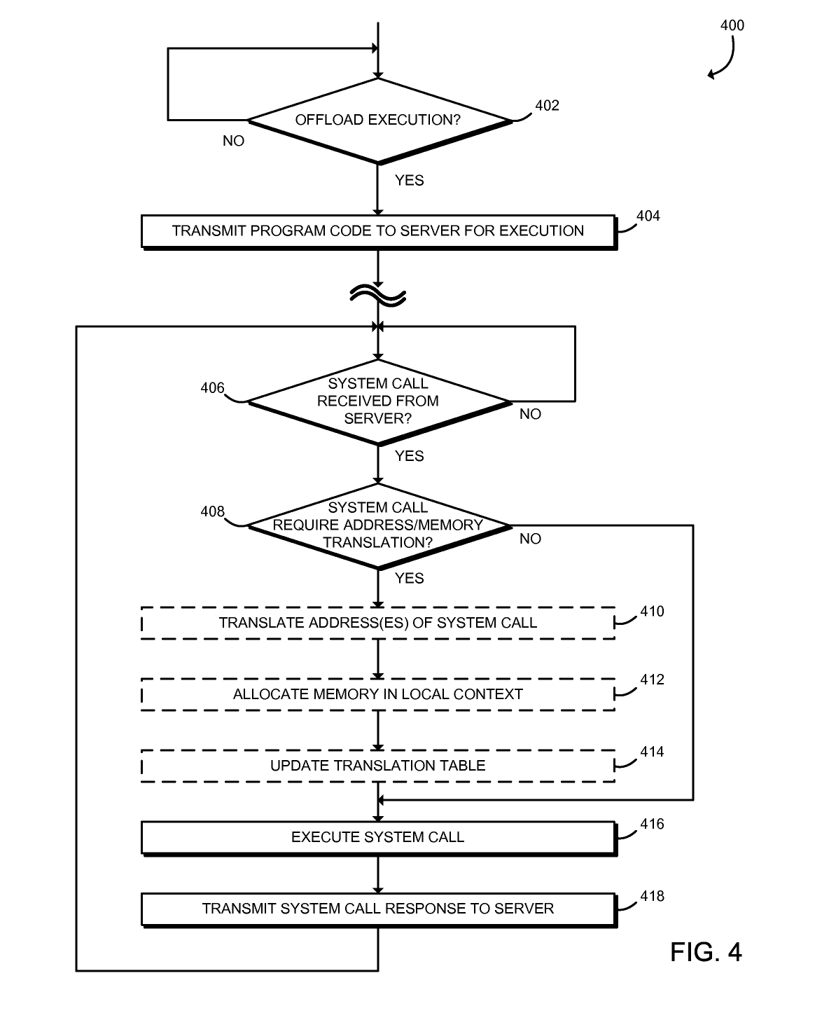

Referring now to FIG. 4, in use, the client computing device 102 of the system 100 may execute a method 400 for offloading execution of program code from the client computing device 102 to the server 106. The illustrative method 400 begins with block 402 of FIG. 4 in which the client computing device 102 determines whether to offload execution. If so, the client computing device 102 transmits the program code to the server 106 for execution in block 404. As discussed above, it is unnecessary in the illustrative embodiment to make any modifications to the program code or to transmit the context of the client computing device 102 in order to offload execution of the program code to the server 106. Additionally, as discussed above, the client computing device 102 may also transmit, along with the program code, execution policies defining system calls requiring execution by the client computing device 102 in block 404.

After some time, which is delineated in FIG. 4 by the double-tilde symbol, the client computing device 102 determines, in block 406, whether a system call has been received from the server 106. As discussed above, after the client computing device 102 transmits the program code to the server 106 for execution, the server 106 loads and executes the program code. If the server 106 traps, or otherwise identifies, an instruction that requires a system call to be executed by the client computing device 102, the server 106 transmits the instruction and/or system call to the client computing device 102 for execution.

As such, if the client computing device 102 receives a system call from the server 106 for execution, the client computing device 102 determines whether the system call requires address/memory translation in block 408. In some embodiments, the client computing device 102 may make such a determination based on the particular system calls received (e.g., by comparing the system call to a database similar to the execution policy database 258 of the server 106). In other embodiments, the server 106 may transmit a supplementary instruction indicating how the client computing device 102 should process, execution, or otherwise handle the program code instruction or system call.

If the client computing device 102 determines the system call requires address/memory translation, the client computing device 102 may translate an address of the system call in block 410. For example, as discussed above, the client computing device 102 may translate an address of the system call (or an address related to the system call) between a memory address of the server 106 and a memory address of the client computing device 102. In block 412, the client computing device 102 may allocate memory in a local context of the client computing device 102. The client computing device 102 may update the translation table 122 (e.g., based on the memory allocation) in block 414. For example, the server 106 may encounter a system call requiring the allocation of memory (e.g., to write a file), which the server 106 executes but also transmits to the client computing device 102 for execution (i.e., memory allocation) on the client computing device 102. Both the server 106 and the client computing device 102 may allocate memory in the corresponding local context. Because the program code is executed on the server 106, the program code will utilize the memory allocated on the server 106; however, the write operation is directed to writing a file on the client computing device 102. As such, the client computing device 102 and the server 106 utilize one or both of the translation tables 122, 162 to translate between addresses of the client computing device 102 and the server 106. Additionally, the translation tables 122, 162 are updated based on any relevant address modifications.

In block 416, the client computing device 102 executes the system call received from the server 106. It should be appreciated that the translation, allocation, and/or updating of blocks 410-414 may be performed as a part of the execution of the system call in some embodiments. In block 418, the client computing device 102 transmits a system call response to the server 106 based on the execution of the system call. As discussed above, the contents of the response may vary depending on the particular embodiment and may include a variety of information related to the execution of the system call by the client computing device 102. In response to transmitting the response to the server 106, the method 400 returns to block 406 in which the client computing device 102 determines whether a system call has been received from the server 106. That is, the client computing device 102 waits until the server 106 transmits a system call requiring execution by the client computing device 102.

### Examples

Illustrative examples of the technologies disclosed herein are provided below. An embodiment of the technologies may include any one or more, and any combination of, the examples described below.

Example 1 includes a server for offloading execution of program code from a client computing device, the server comprising a code execution module to execute the program code received from the client computing device; and a system call management module to (i) monitor execution of the program code to determine whether an instruction of the program code to be executed requires a system call, (ii) transmit the instruction to the client computing device for execution in response to a determination that the instruction requires execution of a system call, and (iii) receive a response from the client computing device in response to execution of the instruction that requires execution of the system call by the client computing device.

Example 2 includes the subject matter of Example 1, and wherein the system call management module is further to determine whether the instruction determined to require a system call requires execution by the client computing device, and wherein to transmit the instruction to the client computing device comprises to transmit the instruction to the client computing device for execution in response to a determination that the instruction requires execution by the client computing device.

Example 3 includes the subject matter of any of Examples 1 and 2, and wherein the system call management module is further to determine whether the instruction determined to require a system call requires execution by the server in response to a determination the instruction does not require execution by the client computing device; and the code execution module is further to execute the instruction determined to require the system call in response to a determination that the instruction requires execution by the server.

Example 4 includes the subject matter of any of Examples 1-3, and wherein the system call management module is further to determine whether the instruction determined to require a system call requires execution by the server in response to a determination that the instruction requires execution by the client computing device; and the code execution module is further to execute the instruction determined to require the system call in response to a determination that the instruction requires execution by the server.

Example 5 includes the subject matter of any of Examples 1-4, and wherein to load the program code comprises to initialize an address/memory translation table that translates addresses between memory addresses of the server and memory addresses of the client computing device.

Example 6 includes the subject matter of any of Examples 1-5, and wherein to execute the instruction that requires execution of the system call comprises to translate an address associated with the system call between a memory address of the server and a memory address of the client computing device.

Example 7 includes the subject matter of any of Examples 1-6, and wherein to execute the instruction that requires execution of the system call comprises to update a translation table based on the execution of the instruction that requires the system call.

Example 8 includes the subject matter of any of Examples 1-7, and wherein the code execution module is further to execute the instruction in response to a determination that the instruction to be executed does not require a system call.

Example 9 includes the subject matter of any of Examples 1-8, and further including a communication module to receive, from the client computing device, the program code to be executed by the server.

Example 10 includes a method for offloading execution of program code from a client computing device to a server, the method comprising loading, by the server, the program code received from the client computing device for execution; determining, by the server, whether an instruction of the program code to be executed requires a system call; transmitting, from the server, the instruction to the client computing device for execution in response to determining the instruction requires execution of a system call; and receiving, by the server, a response from the client computing device in response to execution of the instruction requiring execution of the system call by the client computing device.

Example 11 includes the subject matter of Example 10, and further including determining, by the server, whether the instruction determined to require a system call requires execution by the client computing device, wherein transmitting the instruction to the client computing device comprises transmitting the instruction to the client computing device for execution in response to determining the instruction requires execution by the client computing device.

Example 12 includes the subject matter of any of Examples 10 and 11, and further including determining, by the server, whether the instruction determined to require a system call requires execution by the server in response to determining the instruction does not require execution by the client computing device; and executing, by the server, the instruction determined to require the system call in response to determining the instruction requires execution by the server.

Example 13 includes the subject matter of any of Examples 10-12, and further including determining, by the server, whether the instruction determined to require a system call requires execution by the server in response to determining the instruction requires execution by the client computing device; and executing, by the server, the instruction determined to require the system call in response to determining the instruction requires execution by the server.

Example 14 includes the subject matter of any of Examples 10-13, and wherein loading the program code comprises initializing an address/memory translation table that translates addresses between memory addresses of the server and memory addresses of the client computing device.

Example 15 includes the subject matter of any of Examples 10-14, and wherein execution of the instruction requiring execution of the system call comprises translating an address associated with the system call between a memory address of the server and a memory address of the client computing device.

Example 16 includes the subject matter of any of Examples 10-15, and wherein execution of the instruction requiring execution of the system call comprises updating a translation table based on the execution of the instruction requiring the system call.

Example 17 includes the subject matter of any of Examples 10-16, and further including executing, by the server, the instruction in response to determining the instruction to be executed does not require a system call.

Example 18 includes the subject matter of any of Examples 10-17, and further including receiving, by the server and from the client computing device, the program code to be executed by the server.

Example 19 includes a computing device comprising a processor; and a memory having stored therein a plurality of instructions that when executed by the processor cause the computing device to perform the method of any of Examples 10-18.

Example 20 includes one or more machine-readable storage media comprising a plurality of instructions stored thereon that, in response to being executed, result in a computing device performing the method of any of Examples 10-18.

Example 21 includes a computing device for offloading execution of program code from a client device, the computing device comprising means for loading the program code received from the client device for execution; means for determining whether an instruction of the program code to be executed requires a system call; means for transmitting the instruction to the client device for execution in response to determining the instruction requires execution of a system call; and means for receiving a response from the client device in response to execution of the instruction requiring execution of the system call by the client computing device.

Example 22 includes the subject matter of Example 21, and further including means for determining whether the instruction determined to require a system call requires execution by the client device, wherein the means for transmitting the instruction to the client device comprises means for transmitting the instruction to the client device for execution in response to determining the instruction requires execution by the client device.

Example 23 includes the subject matter of any of Examples 21 and 22, and further including means for determining whether the instruction determined to require a system call requires execution by the server in response to determining the instruction does not require execution by the client device; and means for executing the instruction determined to require the system call in response to determining the instruction requires execution by the server.

Example 24 includes the subject matter of any of Examples 21-23, and further including means for determining whether the instruction determined to require a system call requires execution by the server in response to determining the instruction requires execution by the client device; and means for executing the instruction determined to require the system call in response to determining the instruction requires execution by the server.

Example 25 includes the subject matter of any of Examples 21-24, and wherein the means for loading the program code comprises means for initializing an address/memory translation table that translates addresses between memory addresses of the server and memory addresses of the client device.

Example 26 includes the subject matter of any of Examples 21-25, and wherein means for execution of the instruction requiring execution of the system call comprises means for translating an address associated with the system call between a memory address of the server and a memory address of the client device.

Example 27 includes the subject matter of any of Examples 21-26, and wherein means for execution of the instruction requiring execution of the system call comprises means for updating a translation table based on the execution of the instruction requiring the system call.

Example 28 includes the subject matter of any of Examples 21-27, and further including means for executing the instruction in response to determining the instruction to be executed does not require a system call.

Example 29 includes the subject matter of any of Examples 21-28, and further including means for receiving, from the client device, the program code to be executed by the server.

Example 30 includes a client computing device for offloading execution of program code to a server, the client computing device comprising a code management module to (i) transmit the program code to the server for offloaded execution and (ii) receive, during execution of the program code by the server, an instruction of the program code determined by the server to include a system call; and a system call execution module to execute the instruction determined to include the system call, wherein the communication module is further to transmit, to the server, a response based on the execution of the system call by the client computing device.

Example 31 includes the subject matter of Example 30, and wherein the system call execution module is further to (i) determine whether the received instruction determined to require a system call requires address/memory translation (ii) translate an address of the system call between a memory address of the server and a memory address of the client computing device in response to a determination that the system call requires address/memory translation.

Example 32 includes the subject matter of any of Examples 30 and 31, and wherein the system call execution module is to (i) allocate memory in a local context of the client computing device in response to a determination that the system call requires address/memory translation and (ii) update a translation table based on the memory allocation.

Example 33 includes the subject matter of any of Examples 30-32, and wherein to transmit the response to the server comprises to transmit memory mapping data to the server; and wherein the memory mapping data is based on a mapping between a memory address of the server and a memory address of the client computing device.

Example 34 includes a method for offloading execution of program code from a client computing device to a server, the method comprising transmitting, from the client computing device, the program code to the server for offloaded execution; receiving, by the client computing device and during execution of the program code by the server, an instruction of the program code determined by the server to require a system call; executing, by the client computing device, the instruction determined to require the system call; and transmitting, from the client computing device and to the server, a response based on the execution of the system call by the client computing device.

Example 35 includes the subject matter of Example 34, and further including determining, by the client computing device, whether the received instruction determined to require a system call requires address/memory translation; and translating, by the client computing device, an address of the system call between a memory address of the server and a memory address of the client computing device in response to determining the system call requires address/memory translation.

Example 36 includes the subject matter of any of Examples 34 and 35, and further including allocating, by the client computing device, memory in a local context of the client computing device in response to determining the system call requires address/memory translation; and updating, by the client computing device, a translation table based on the memory allocation.

Example 37 includes the subject matter of any of Examples 34-36, and wherein transmitting the response to the server comprises transmitting memory mapping data to the server, wherein the memory mapping data is based on a mapping between a memory address of the server and a memory address of the client computing device.

Example 38 includes a computing device comprising a processor; and a memory having stored therein a plurality of instructions that when executed by the processor cause the computing device to perform the method of any of Examples 34-37.

Example 39 includes one or more machine-readable storage media comprising a plurality of instructions stored thereon that, in response to being executed, result in a computing device performing the method of any of Examples 34-37.

Example 40 includes a computing device for offloading execution of program code to a server, the computing device comprising means for transmitting the program code to the server for offloaded execution; means for receiving, during execution of the program code by the server, an instruction of the program code determined by the server to require a system call; means for executing the instruction determined to require the system call; and means for transmitting, to the server, a response based on the execution of the system call by the computing device.

Example 41 includes the subject matter of Example 40, and further including means for determining whether the received instruction determined to require a system call requires address/memory translation; and means for translating an address of the system call between a memory address of the server and a memory address of the computing device in response to determining the system call requires address/memory translation.

Example 42 includes the subject matter of any of Examples 40 and 41, and further including means for allocating memory in a local context of the computing device in response to determining the system call requires address/memory translation; and means for updating a translation table based on the memory allocation.

Example 43 includes the subject matter of any of Examples 40-42, and wherein the means for transmitting the response to the server comprises means for transmitting memory mapping data to the server; and wherein the memory mapping data is based on a mapping between a memory address of the server and a memory address of the computing device.

1-25. (canceled)

26. A server for offloading execution of program code from a client computing device, the server comprising:
a code execution module to execute the program code received from the client computing device; and
a system call management module to (i) monitor execution of the program code to determine whether an instruction of the program code to be executed requires a system call, (ii) transmit the instruction to the client computing device for execution in response to a determination that the instruction requires execution of a system call, and (iii) receive a response from the client computing device in response to execution of the instruction that requires execution of the system call by the client computing device.

27. The server of claim 26, wherein the system call management module is further to determine whether the instruction determined to require a system call requires execution by the client computing device, and
wherein to transmit the instruction to the client computing device comprises to transmit the instruction to the client computing device for execution in response to a determination that the instruction requires execution by the client computing device.

28. The server of claim 27, wherein:
the system call management module is further to determine whether the instruction determined to require a system call requires execution by the server in response to a determination the instruction does not require execution by the client computing device; and
the code execution module is further to execute the instruction determined to require the system call in response to a determination that the instruction requires execution by the server.

29. The server of claim 27, wherein:
the system call management module is further to determine whether the instruction determined to require a system call requires execution by the server in response to a determination that the instruction requires execution by the client computing device; and
the code execution module is further to execute the instruction determined to require the system call in response to a determination that the instruction requires execution by the server.

30. The server of claim 26, wherein to load the program code comprises to initialize an address/memory translation table that translates addresses between memory addresses of the server and memory addresses of the client computing device.

31. The server of claim 26, wherein to execute the instruction that requires execution of the system call comprises to translate an address associated with the system call between a memory address of the server and a memory address of the client computing device.

32. The server of claim 26, wherein to execute the instruction that requires execution of the system call comprises to update a translation table based on the execution of the instruction that requires the system call.

33. The server of claim 26, wherein the code execution module is further to execute the instruction in response to a determination that the instruction to be executed does not require a system call.

34. The server of claim 26, further comprising a communication module to receive, from the client computing device, the program code to be executed by the server.

35. One or more machine-readable storage media comprising a plurality of instructions stored thereon that, in response to execution by a server, causes the server to:
load program code received from a client computing device for execution;
determine whether an instruction of the program code to be executed requires a system call;
transmit the instruction to the client computing device for execution in response to a determination that the instruction requires execution of a system call; and
receive a response from the client computing device in response to execution of the instruction requiring execution of the system call by the client computing device.

36. The one or more machine-readable storage media of claim 35, wherein the plurality of instructions further cause the server to determine whether the instruction determined to require a system call requires execution by the client computing device; and
wherein to transmit the instruction to the client computing device comprises to transmit the instruction to the client computing device for execution in response to a determination that the instruction requires execution by the client computing device.

37. The one or more machine-readable storage media of claim 36, wherein the plurality of instructions further cause the server to:
determine whether the instruction determined to require a system call requires execution by the server in response to a determination that the instruction does not require execution by the client computing device; and
execute the instruction determined to require the system call in response to a determination that the instruction requires execution by the server.

38. The one or more machine-readable storage media of claim 36, wherein the plurality of instructions further cause the server to:
determine whether the instruction determined to require a system call requires execution by the server in response to a determination that the instruction requires execution by the client computing device; and
execute the instruction determined to require the system call in response to a determination that the instruction requires execution by the server.

39. The one or more machine-readable storage media of claim 35, wherein to load the program code comprises to initialize an address/memory translation table that translates addresses between memory addresses of the server and memory addresses of the client computing device.

40. The one or more machine-readable storage media of claim 35, wherein execution of the instruction requiring execution of the system call comprises translation of an address associated with the system call between a memory address of the server and a memory address of the client computing device.

41. The one or more machine-readable storage media of claim 35, wherein execution of the instruction requiring execution of the system call comprises to update a translation table based on the execution of the instruction requiring the system call.

42. The one or more machine-readable storage media of claim 35, wherein the plurality of instructions further cause the server to execute the instruction in response to a determination that the instruction to be executed does not require a system call.

43. A method for offloading execution of program code from a client computing device to a server, the method comprising:
loading, by the server, the program code received from the client computing device for execution;
determining, by the server, whether an instruction of the program code to be executed requires a system call;
transmitting, from the server, the instruction to the client computing device for execution in response to determining the instruction requires execution of a system call; and
receiving, by the server, a response from the client computing device in response to execution of the instruction requiring execution of the system call by the client computing device.

44. The method of claim 43, further comprising determining, by the server, whether the instruction determined to require a system call requires execution by the client computing device,
wherein transmitting the instruction to the client computing device comprises transmitting the instruction to the client computing device for execution in response to determining the instruction requires execution by the client computing device.

45. The method of claim 44, further comprising:
determining, by the server, whether the instruction determined to require a system call requires execution by the server in response to determining the instruction does not require execution by the client computing device; and
executing, by the server, the instruction determined to require the system call in response to determining the instruction requires execution by the server.

46. The method of claim 44, further comprising:
determining, by the server, whether the instruction determined to require a system call requires execution by the server in response to determining the instruction requires execution by the client computing device; and
executing, by the server, the instruction determined to require the system call in response to determining the instruction requires execution by the server.

47. The method of claim 43, wherein loading the program code comprises initializing an address/memory translation table that translates addresses between memory addresses of the server and memory addresses of the client computing device.

48. The method of claim 43, wherein execution of the instruction requiring execution of the system call comprises translating an address associated with the system call between a memory address of the server and a memory address of the client computing device.

49. The method of claim 43, wherein execution of the instruction requiring execution of the system call comprises updating a translation table based on the execution of the instruction requiring the system call.

50. The method of claim 43, further comprising executing, by the server, the instruction in response to determining the instruction to be executed does not require a system call.
